(19) United States
(12) Patent Application Publication
(10) Pub. No.: US 2026/0266543 A1
(43) Pub. Date: Sep. 10, 2026

(54) BURNER DEVICE FOR AN ASPHALT PRODUCTION PLANT, PLANT COMPRISING A BURNER DEVICE OF THIS TYPE, AND METHOD FOR SUPPLYING HEAT TO A ROTARY KILN OF A BURNER DEVICE

(71) Applicant: Benninghoven Zweigniederlassung der Wirtgen Mineral Technologies GmbH, Wittlich (DE)

(72) Inventors: Dietmar ZIMMER, Longkamp (DE); Matthias Walter JOHANN, Bad Bertrich (DE); Marius KLOFT, Wittlich (DE); Johannes JUNG, Bernkastel-Kues (DE)

(21) Appl. No.: 19/162,914

(22) PCT Filed: Mar. 18, 2024
(86) PCT No.: PCT/EP2024/057180

§ 371 Date: Sep. 5, 2025

(30) Foreign Application Priority Data
Mar. 23, 2023 (DE) 10 2023 202 662.7

(51) Int. Cl. F26B 11/02; E01C 19/05; F26B 21/25; F26B 23/02

(52) U.S. Cl. CPC F26B 11/028; E01C 19/05; F26B 21/25; F26B 23/022

(57) ABSTRACT

A burner device for a plant (1) for producing asphalt comprises a rotary kiln (9) drivable in rotation about an axis of rotation (29) for drying material, a burner (12) coupled to the rotary kiln (9) for supplying heat to the rotary kiln (9), the burner (12) comprising an air line (19) connected to the burner (12) for supplying air, a fuel gas line (14) connected to the burner (12) for supplying fuel gas and at least one secondary gas line (24, 35) connected to the burner (12) for supplying secondary gas.

### BACKGROUND

The present patent application claims the priority of German patent application DE 10 2023 202 662.7, the contents of which are incorporated here by reference.

The invention relates to a burner device for a plant for producing asphalt, to a plant comprising a burner device of this type, and to a method for supplying heat to a rotary kiln of a burner device.

In an asphalt production plant, various materials are processed, in particular heated, dried and/or mixed together. A large part of the energy input required for the subsequent asphalt mixing process is generated for drying the materials during asphalt production. The materials are heated during drying. The temperature level is up to 450° C., depending on the type of asphalt to be mixed and in particular on the proportion of old asphalt granulate, also referred to as recycled material, to be added. Drying takes place in a rotary kiln, also known as a drying drum. Heat generated by a separate heating unit is supplied in the rotary kiln. Heat generation is usually based on the combustion of fossil fuels such as natural gas, liquefied petroleum gas, heating oil and/or coal dust. The combustion of fossil fuels is problematic for the climate.

Other, non-fossil fuel gases, such as hydrogen, have a high reaction rate and lead to high flame temperatures, and so burners known per se cannot readily be used for burning fuel gases of this type.

### SUMMARY

The object of the present invention is to improve the provision of heat and the supply thereof to a rotary kiln during the production of asphalt, in particular in terms of climate-related aspects and in particular with an inexpensive configuration.

This object is achieved according to the invention by a burner device, a plant and by a method having the features of the disclosure.

According to the invention, it has been found that a fuel gas can be efficiently and selectively burnt in a burner to generate heat if secondary gas is additionally supplied to the burner. It is true that the fuel gas, in particular hydrogen and/or acetylene, has a comparatively high reaction rate, meaning that high flame temperatures, in particular with local temperature peaks, can occur when the fuel gas is burnt alone. However, the combustion reaction rate in the burner can be selectively reduced by also burning the secondary gas. This means that the combustion reaction in the burner is slowed down by adding the secondary gas.

In particular, the fuel gas nozzle and secondary gas nozzle are arranged in such a way that the supply of the fuel gas and secondary gas takes place separately from the supply of air to the combustion chamber. In particular, the fuel gas and secondary gas are supplied to the combustion chamber together, but separately from air. In particular, a mixture of fuel gas and secondary gas is generated, and this mixture is supplied by means of the nozzle arrangement to the combustion chamber, where mixing with air takes place. In particular, there is no mixing of air with the fuel gas and secondary gas before the combustion chamber. There is no mixing of the fuel gas with air in the nozzle arrangement. In particular, no air is supplied to the nozzle arrangement.

In particular, the fuel gas and secondary gas are mixed in the absence of air. The mixture of fuel gas and secondary gas is subsequently mixed with air in the combustion chamber.

Hydrogen has a flame temperature in air of 2130° C. Nitrogen oxides are formed at a combustion temperature of approximately 1400° C., the amount thereof increasing approximately exponentially with further rising temperatures.

In particular the fuel gas as primary fuel gas, the secondary gas, and air are processed in the burner. In particular, the secondary gas differs from air. In particular, the secondary gas is air-free. Optionally, a secondary fuel gas may be supplied and co-combusted. What is essential is that only gases are processed in the burner. The burner is in particular a gas burner. Liquids and/or solids as fuels are not processed in the burner according to the invention.

According to the invention, it has been found that this reduces the fuel conversion per unit volume. This reduces and in particular prevents high-temperature zones in the burner. Reducing the high-temperature zones makes the combustion reaction gentle on the burner. The service life of the burner is increased. The burner device according to the invention is ecologically and economically advantageous. In particular, it has been found that high-temperature zones of this type are a significant cause of the formation of nitrogen oxide (NOₓ) emissions. Reducing nitrogen oxide emissions makes the method according to the invention environmentally friendly. In particular, formation of nitrogen oxides can be prevented directly during combustion.

According to the invention, the heat is generated at least in part and in particular exclusively by the combustion of hydrogen gas as fuel gas. The combustion of hydrogen gas is free from carbon dioxide. No carbon dioxide is produced during the combustion of hydrogen gas. The combustion of hydrogen gas is climate-friendly. Harmful exhaust gases and/or emissions are reduced. It is particularly advantageous if the hydrogen gas is generated from renewable energies, or in other words if it is green hydrogen.

The burner is used to supply heat to a rotary kiln. For this purpose, the burner is coupled to the rotary kiln. A burner flame generated by the burner may burn directly in the rotary kiln. In this case, the burner and rotary kiln are physically coupled to one another. In this case, the burner is arranged directly at the rotary kiln. Alternatively, the burner flame may burn at a spatial distance from the rotary kiln, in particular in a hot gas generator. The heat thus generated can be conducted as hot gas from the hot gas generator to the rotary kiln. The heat generated by the burner is supplied to the rotary kiln as hot gas. In this case, the burner is coupled to the rotary kiln indirectly, in particular via a hot gas line.

The burner has an intake chamber for drawing air, in particular ambient air, into a burner housing. In particular an air line is connected to the burner to supply air, in particular ambient air. This makes it possible to generate a mixture of fuel gas and combustion air in the burner to improve the combustion of the fuel gas.

An exhaust gas return line according to claim 2 makes straightforward provision of secondary gas possible. It has in particular been found that exhaust gas from the burner device can advantageously be used to slow the combustion reaction.

A burner device according to claim 3 makes it possible to integrate various exhaust gas sources. The rotary kiln itself may be used as exhaust gas sources for recirculating exhaust gases. In particular, the exhaust gases from the rotary kiln are returned directly to the burner by means of the exhaust gas return line. Additionally or alternatively, at least one further exhaust gas source may be provided, from which exhaust gases are passed to the burner. The at least one further exhaust gas source is in particular another rotary kiln, a bucket conveyor, a chimney and/or a filter unit, in particular a filter deduster. In particular, a plurality of exhaust gas return lines may be provided, which lead from various exhaust gas sources to the burner. In particular, an exhaust gas return line system is provided, by means of which the rotary kiln and/or the at least one further exhaust gas source are fluidically connected, in particular at least indirectly, to the burner.

An exhaust gas purification unit according to claim 4 ensures that the returned exhaust gas has a reduced dust content. In particular, the exhaust gas is dust-free, in other words has substantially no dust content. The exhaust gas is in particular flue gas, in which the proportion of dust particles is less than 20 mg/m³ and in particular less than 10 mg/m³. It has surprisingly been found that purified exhaust gas and in particular flue gas is particularly advantageous for slowing the combustion reaction.

Alternatively, it is possible to allow at least partial loading of the exhaust gas with dust. In particular, the dust load is less than 35 mg/m³.

An inert gas line according to claim 5 makes targeted supply of inert gas to the burner possible. According to the invention, it has been found that the use of inert gas can selectively slow the combustion reaction in the burner. Inert gas refers to gases having a higher inert content than ambient air. Examples of inert gases include nitrogen, water vapour, or noble gases such as helium, neon, argon, krypton, xenon and/or radon.

In particular, the inert gas line is connected to an inert gas source, in particular an inert gas storage container.

A mixing chamber according to claim 6 improves the combustion process. The mixing chamber is for mixing fuel gas and secondary gas. The mixing chamber is in particular arranged upstream from the burner and/or integrated onto or into the burner, in particular in a nozzle and in particular in a nozzle combination. The mixing chamber makes premixing of the fuel gas with the secondary gas possible, in particular before the fuel gas is mixed with air in the burner. The risk of an undesirable uncontrolled increase in flame temperatures occurring, for example because fuel gas is inadvertently burnt undiluted in the burner, is reduced and in particular eliminated.

Alternatively, it is possible to supply each of the fuel gas and the secondary gas to the burner separately. It is then particularly advantageous if the fuel gas and secondary gas are supplied selectively in such a way that unwanted combustion of the fuel gas occurs in isolation, in other words without the braking effect of the secondary gas. Supplying fuel gas and secondary gas selectively and separately can slow the combustion reaction.

A burner device according to claim 7 facilitates controlled slowing of the combustion of the fuel gas. By selectively supplying secondary gas to the mixing chamber and mixing it with the fuel gas, undesirable temperature peaks can be avoided.

A burner device according to claim 8 makes it possible to avoid undesirable, in particular undesirably premature, combustion of the fuel gas. Because the air is guided past the mixing chamber and only supplied downstream from the combustion chamber, the possibility of the fuel gas burning in the mixing chamber is excluded.

A system according to claim 9 has the advantages of the burner device, to which reference is hereby made.

A method according to claim 10 ensures efficient and advantageous combustion of a fuel gas.

Both the features set out in the claims and the features set out in the following embodiment of a burner device according to the invention are suitable, each in its own right or in combination with one another, for developing the subject matter of the invention. The respective feature combinations do not constitute a limitation on developments to the subject matter of the invention, but are basically purely exemplary in nature.

### BRIEF DESCRIPTION OF THE DRAWINGS

Additional features, advantageous embodiments and details of the invention will become apparent from the following description of an embodiment with reference to the drawings, in which:

FIG. 1 is a schematic sketch of an asphalt production plant comprising a burner device according to the invention,

FIG. 2 is a schematic sectional view of a rotary kiln comprising a burner according to FIG. 1,

FIG. 3 is a view along the section line III-III of FIG. 2,

FIG. 4 is an enlarged drawing of the detail IV of FIG. 2,

FIG. 5 is an enlarged, perspective detail of a nozzle arrangement according to FIG. 4.

### DETAILED DESCRIPTION

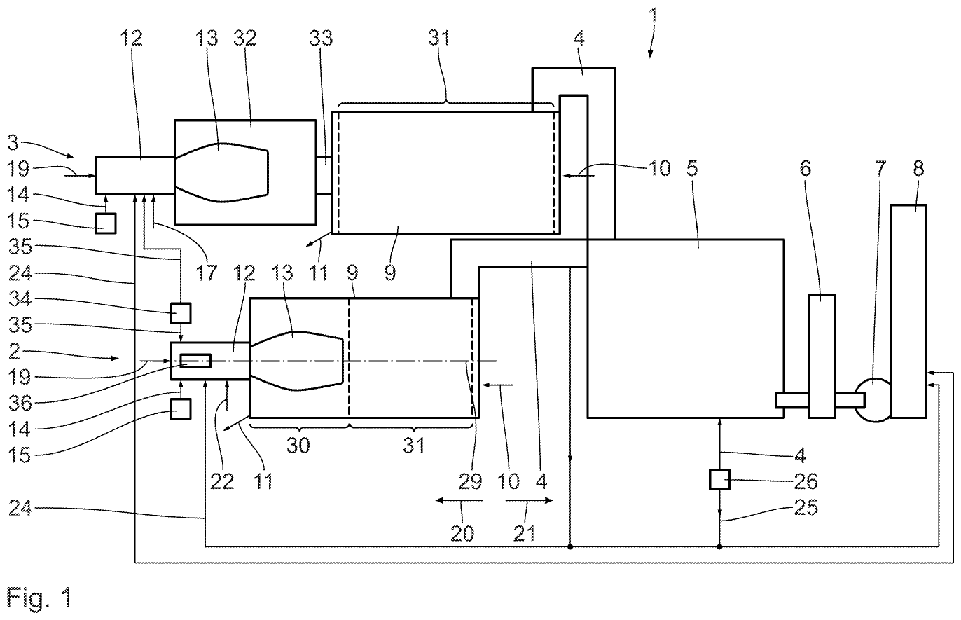

A plant, represented as a whole as 1 in FIG. 1, is used for producing asphalt. The plant 1 comprises a first device 2 and a second device 3, each of which is connected via an emission line 4 to an in particular common filter dedusting system 5.

The plant 1 may also have only one device 2, 3 or more than two devices 2, 3. It is conceivable for the one or more devices 2, 3 to be connected to the filter dedusting system 5 via a common emission line 4. In particular, the filter dedusting system 5 is a central filter dedusting system of the plant 1, a plurality and in particular all of the devices 2, 3 of the plant 1 being connected to the filter dedusting system 5. It is also conceivable for each device 2, 3 to be assigned to and connected to a separate filter dedusting system 5.

Optionally, a condensate separator 6, connected to a chimney 8 via a blower 7, is connected to the filter dedusting system 5. As is shown in FIG. 1, the condensate separator 6 may be arranged downstream from the filter dedusting system 5 and additionally or alternatively upstream from the filter dedusting system 5. In particular, in addition to the condensate separator 6, a recuperation unit (not shown) is provided, which is for recovering process heat generated in particular in the condensate separator 6. For this purpose, the recuperation unit may be arranged in particular integrated into the condensate separator 6.

It has been found that the condensate separator 6 can advantageously be used in the plant 1 if the exhaust air of the devices 2, 3 is comparatively clean, in other words has a reduced pollution level and in particular is less heavily polluted than the exhaust air of a burner which burns fossil fuels.

Alternatively, it is possible for the plant 1 to be configured without a filter dedusting system 5. In this case, the devices 2, 3 are directly connected to the condensate separator 6. It is also conceivable for a plurality of condensate separators 6 to be present, in particular one condensate separator 6 for each device 2, 3.

The first device 2 comprises a rotary kiln 9 in which material is dried. The rotary kiln 9 has a material inlet 10 and a material outlet 11. In the embodiment shown, the material inlet 10 and the material outlet 11 are each arranged at an end face of the rotary kiln 9, in particular opposite one another.

A burner 12 is coupled to the rotary kiln 9. The burner 12 is configured to burn hydrogen gas as fuel gas and to generate a burner flame 13, which is arranged at least in part in the rotary kiln 9. The burner 12 is a hydrogen burner. The fuel gas forms in particular a primary fuel. Primary fuel is primarily, in other words mainly, a fuel for generating heat in the burner 12. In particular, hydrogen is burnt solely for heat generation in the burner 12. A fuel gas line 14, in particular connected to a fuel gas reservoir 15, is connected to the burner 12. The fuel gas reservoir 15 is in particular a storage container, in particular a storage tank, in which the fuel gas, in other words hydrogen, is stored in reserve, in particular in a gaseous form. The fuel gas reservoir 15 may also be configured as a connection to a fuel gas supply network.

The connector of a gas control portion of the fuel gas line 14 is connected to a fuel gas distribution chamber 17 of the burner 12 via a compensator 16. The fuel gas distribution chamber 17 forms a fuel gas distribution device. Other configurations of the fuel gas distribution device are also possible, for example a pipeline, a distributor element or a manifold. The compensator 16 is a flexible compensation element. The compensator 16 is for compensating for movements of the fuel gas line 14, in particular as a result of thermal length changes, vibrations, wall penetrations and/or subsidence events. The compensator 16 is arranged at a flange connection 18 between the fuel gas distribution chamber 17 and the fuel gas line 14.

An air line 19 is connected to the burner 12 to supply air, in particular ambient air.

A material conveying direction 20 through the rotary kiln 9 is directed from the material inlet 10 to the material outlet 11 and is orientated from right to left in FIG. 1. A gas conveying direction 21 through the rotary kiln 9 is directed from the burner 12 to the emission line 4, in other words from left to right in FIG. 1. The material conveying direction 20 and the gas conveying direction 21 are orientated counter to one another. The rotary kiln 9 is operated in a counter-current process. The rotary kiln 9 may also be operated in a co-current process.

A secondary fuel line 22 may be connected to the burner 12 to supply secondary fuel to the burner 12. In particular fossil fuels, such as natural gas, liquefied petroleum gas, heating oil, coal (in particular coal dust), synthetic fuels (BtL) and/or wood dust, are used as secondary fuel. The secondary fuel line 22 is supplied from a secondary fuel reservoir (not shown). Similarly to the fuel gas reservoir 15, the secondary fuel reservoir may be configured as a storage tank and/or a supply network.

The connection of the burner 12 to the secondary fuel line 22 and to the gas control portion there is made via a secondary fuel distribution chamber 23 by means of a compensator 16. The compensator 16 is substantially identical to the compensator 16 on the fuel gas line 14 and is arranged at a corresponding location between the secondary fuel line 22 and secondary fuel distribution chamber 23.

The first device 2 further comprises an exhaust gas return line 24 connected to the burner 12. The exhaust gas return line 24 may additionally be directly connected, in particular via a branch line (not shown), to the rotary kiln 9. The exhaust gas return line 24 is for returning exhaust gas to the burner 12. The exhaust gas return line 24 is in particular for the internal recirculation of exhaust gases from the rotary kiln 9. The exhaust gas return line 24 is directly connected to the chimney 8. Exhaust gas, in particular purified exhaust gas, in particular flue gas, is returned to the burner 12 via the exhaust gas return line 24. In addition, an exhaust gas bypass line 25 may be provided, by means of which the emissions line 4 is directly connected to the exhaust gas return line 24. Dust-laden exhaust gas can be supplied to the burner 12 via the exhaust gas bypass line 25.

The plant 1 may have additional exhaust gas sources 26, such as filter elements. These additional exhaust gas sources may be connected directly to the exhaust gas return line 24 via an exhaust gas bypass line 25. Additionally or alternatively, the exhaust gas sources 26 may be connected to the filter dedusting system 5 via an emissions line 4. This makes it possible to supply purified exhaust gas from the at least one exhaust gas source 26 to the burner 12.

A separate fan 27 is arranged in the exhaust gas return line 24 to improve the supply of exhaust gas to the burner 12. One or more dampers 28 may be arranged along the exhaust gas return line 24 to selectively control the exhaust gas flow and, in particular, to selectively adjust the amount of exhaust gas added. Additionally or alternatively, the exhaust gas flow rate may also be controlled using the fan 27 and in particular by means of a frequency converter connected thereto.

In the embodiment shown, the exhaust gas return line 24 is branched, a first branch opening directly into the rotary kiln 9. Another branch of the exhaust gas return line 24 opens into the burner 12.

The rotary kiln 9 is configured to be drivable in rotation about an axis of rotation 29. The drives required for this purpose, in particular rotary drives, are known per se and are not shown in the figures for reasons of clarity.

The rotary kiln 9 has a burnout zone 30 extending along the axis of rotation 29 in the region of the burner flame 13. The rotary kiln 9 further has a heat transfer region 31 in which heat is transferred to the material by convection.

The second device 3 is constructed substantially identically to the first device 2, to which reference is hereby made. One difference is that the second device 3 comprises a hot gas generator 32 in addition to the burner 12. The hot gas generator 32 is connected to the rotary kiln 9 by means of a hot gas line 33. The hot gas generator 32 is arranged between the burner 12 and the rotary kiln 9. In the second device 3, the burner 12 is configured separate from the rotary kiln 9. In particular, the burner 12 is arranged completely outside the rotary kiln 9. Accordingly, the burner flame 13 is arranged in the hot gas generator 32. The burner flame 13 is arranged outside the rotary kiln 9 of the second device 3.

In the second device 3, recirculating air fans and/or exhaust air fans (not shown in detail) may be used for air guidance, in particular within the rotary kiln 9 and/or in the hot gas generator 32. The fans are arranged in particular outside the rotary kiln 9 and/or outside the hot gas generator 32, in particular along connecting lines. Accordingly, the burnout zone 30 is not required in the rotary kiln 9 of the second device 3. The rotary kiln 9 of the second device 3 substantially exclusively comprises a heat transfer region 31.

Accordingly, an exhaust gas return line 24 from the chimney 8 to the burner 12 of the second device 3 is provided. In the embodiment shown, the exhaust gas return line 24 to the second device 3 is configured separate from the exhaust gas return line 24 to the first device 2. It is also possible to configure a common exhaust gas return line 24 with corresponding branches. Accordingly, exhaust gas bypass lines 25 can be connected to the exhaust gas return line 24 to the second device 3. In particular, the rotary kiln 9 of each device may constitute an additional exhaust gas source for the other device.

In the embodiment shown, each device 2, 3 has its own separate fuel gas reservoir 15. It is possible for a common, centrally located fuel gas reservoir 15, in fluid communication with a plurality and in particular with all of the burners 12 of the plant 1, to be available in the plant 1.

The plant 1 accordingly has a central inert gas reservoir 34, also referred to as an inert gas source. Inert gas is stored in the inert gas reservoir 34. The inert gas has in particular a higher inert proportion than ambient air. In particular nitrogen is used as the inert gas. The inert gas reservoir 34 is connected to the burners 12 of each of the first device 2 and the second device 3 via an inert gas line 35. It will be appreciated that a separate inert gas reservoir 34 may also be implemented for each burner 12. This makes it possible in particular to supply different inert gases to each burner 12.

The exhaust gas return line 24 and the inert gas line 35 each form a secondary gas line for supplying secondary gas to the burner 12. Secondary gas within the meaning of the invention may be exhaust gas, in particular purified exhaust gas, and/or inert gas. The secondary gas can be used to selectively influence, in particular to slow, a combustion reaction in the burner 12.

The burner 12 has a mixing chamber 36, which is integrated into the burner 12. The mixing chamber 36 is for mixing the fuel gas with the secondary gas. The mixing chamber 36 is arranged in particular in such a way that the fuel gas is initially mixed with the secondary gas before air is supplied from the air line 19. In particular, the fuel gas line 14 and the exhaust gas return line 24 and/or the inert gas line 35 are fluidically connected to the mixing chamber 36. It is also conceivable for the mixing chamber to be arranged outside the burner 12, in particular on the burner 12. The mixing chamber 36 may also be arranged external to and spaced apart from the burner 12 and in particular upstream from the burner 12. It is conceivable to mix the fuel gas and secondary gas separately before supplying them to the burner 12.

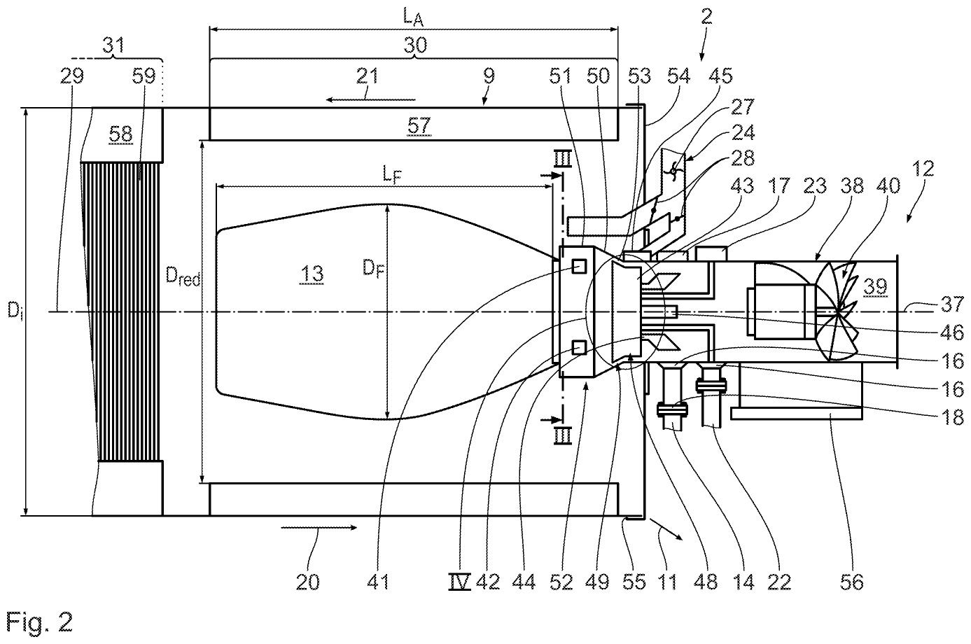

The construction and functionality of the first device 2, in particular the burner 12, are explained in greater detail in the following with reference to FIG. 2.

The burner 12 has a burner housing 38 having a longitudinal axis 37. The burner housing 38 has, at an end facing away from the rotary kiln 9, an intake chamber 39 through which air, in particular ambient air, is drawn into the burner housing 38. For this purpose, the air line 19 and/or a silencer can be connected to the intake chamber 39. An air blower 40 is arranged along the burner housing 38, and in the embodiment shown is configured as an axial blower. It will be appreciated that the air blower 40 may also be configured as a different type of blower, in particular as a radial blower.

The burner 12 has in particular a flame sensor 41 for monitoring the burner flame 13. In particular, a plurality of flame sensors 41 may be implemented on the burner 12 and be arranged mutually spaced apart, in particular in the burner housing 38, in particular along the longitudinal axis 37. Furthermore, an ignition burner 42 for igniting the burner flame 13 is present in the burner housing 38.

The fuel gas line 14 is connected to the burner housing 38 via the fuel gas distribution chamber 17. The fuel gas distribution chamber 17 is arranged annularly around the burner housing 38. At least one fuel gas nozzle 43 is connected to the fuel gas distribution chamber 17 so as to supply the fuel gas selectively to the burner housing 38. In particular, a plurality of fuel gas nozzles 43 are provided.

Accordingly, at least one and in particular a plurality of secondary fuel nozzles 44 are connected to the secondary fuel distribution chamber 23. The secondary fuel nozzles 44 may be configured as gas lances and may be arranged in particular adjacent to the fuel gas nozzles 43 in the burner housing 38.

The secondary gas lines, in other words the exhaust gas return line 24 and/or the inert gas line 35, are connected to a secondary gas distribution chamber 45 of the burner 12. The secondary gas distribution chamber 45 forms a secondary gas distribution device and is configured analogously to the fuel gas distribution chamber 17, to which reference is hereby made. The secondary gas distribution chamber 45 extends in particular annularly around the burner housing 38. At least one and in particular a plurality of secondary gas nozzles 46, for selectively discharging secondary gas to the burner housing 38, are connected to the secondary gas distribution chamber 45.

The at least one fuel gas nozzle 43 and the at least one secondary gas nozzle 46 form a nozzle arrangement 47, which is shown purely schematically and in a simplified manner in FIG. 2.

In the region of the nozzle arrangement 47, in particular upstream from the nozzle arrangement 47, a swirling element 48, also shown purely schematically, is arranged in the burner housing 38. The swirling element 48 is for swirling the air tangentially. The swirling element 48 is configured in particular as a baffle plate, which in particular has a guide wheel. Depending on the fuel combination used, and thus in particular depending on the secondary fuel, in particular on a secondary combustion gas, the swirling element 48 may be configured differently in terms of diameter, shape and/or structural details.

It is also conceivable to arrange the nozzle arrangement 47 upstream from the swirling element 48 and/or to arrange individual nozzles 43, 46 upstream and/or downstream from the swirling element 48.

The swirling element 48 is arranged in a cooling cone 49 of the burner 12. In the embodiment shown, the cooling cone 49 has a cylindrical portion whose external diameter is at least 80% of the internal diameter of the burner housing 38 at this point. In particular, the external diameter of the cooling cone 49 is at least 85%, in particular at least 90%, in particular at least 95% and in particular at most 99% of the internal diameter of the burner housing 38 at this point. The cooling cone 49 is arranged in particular in a region of the burner housing 38 in which the burner housing 38 widens conically. The burner housing 38 has an expanding portion 50 which merges into a cylindrical end portion 51. The end portion 51 and the expanding portion 50 form a burner head 52. A circumferential, in particular conically configured, annular gap 53 is formed between an outer wall of the cooling cone 49 and an inner wall of the burner head 52. The air flowing through this annular gap 53 is referred to as secondary air. The secondary air thus flows past the cooling cone 49. The air flowing centrally through the cooling cone 49 is referred to as primary air. Because at least a portion of the air flows around the cooling cone 49 as secondary air, air staging is possible.

In the embodiment shown, the burner head 52 improves the mixing of the combustion gases, in particular of hydrogen with air. The burner flame 13 is formed downstream from the burner head 52, the shape of the burner flame being influenced by the geometry of the burner head. This means that the shape of the burner flame 13 can be selectively adjusted by suitably selecting the burner head geometry. In particular, the greater the diameter at the outlet of the burner head 52, the greater the diameter D_{F} of the burner flame 13.

The burner 12 is fastened to an end wall 54 of the rotary kiln 9. The end wall 54 is referred to as the outlet end wall because the material outlet 11 is located in this region. The burner 12, in particular the burner housing 38, is fastened to the end wall 54 by means of fastening elements (not shown in detail).

The end wall 54 is arranged on the rotary kiln 9 overlapping in the axial direction and/or in the radial direction in terms of the axis of rotation 29. The end wall 54 forms a cover for a cylindrical opening of the rotary kiln 9. In particular, the rotary kiln 9 is not hermetically sealed by the end wall 54. A circumferential gap 55 remains between the end wall 54 and the rotary kiln 9. The circumferential gap 55 makes possible an additional supply of air, in particular ambient air, to the rotary kiln 9.

The burner 12 is arranged on the rotary kiln 9 in particular in such a way that its longitudinal axis 37 and the axis of rotation 29 of the rotary kiln 9 are coincident, in other words identical. The burner 12 is arranged concentric with the rotary kiln 9. The burner 12 is directly fastened to and integrated at least in part into the rotary kiln 9. In particular, the burner head 52 and the burner flame 13 generated by the burner 12 are arranged, in particular entirely, within the rotary kiln 9.

The burner 12 has a burner frame 56 via which the burner 12 is placed on a base. In the embodiment shown, the burner frame 56 is configured static, in other words stationary, in particular fixed. The burner frame 56 may also be configured displaceable, in particular along the longitudinal axis 37. For this purpose, the burner frame 56 may, on its lower face, have rollers, which may roll in particular on suitable rails. For axial displacement of the burner 12, an axial drive is advantageous, in particular a pneumatic drive.

Along the longitudinal axis 37 or the axis of rotation 29, the burner flame 13 has a length L_{F} and a diameter D_{F} orientated perpendicular thereto.

The rotary kiln 9 has an internal diameter Dᵢ. In the burnout zone 30 there are fire protection internals 57 fastened to the inner wall of the rotary kiln 9. As a result of the fire protection internals 57, there is a reduced internal diameter D_{red} in the burnout zone 30. In the axial direction, the fire protection internals 47 extend along a length L_{A} corresponding to the length of the burnout zone 30. What is essential is that the length L_{A} of the burnout zone 30 is greater than the length L_{F} of the burner flame 13 and that the burner 12 is arranged on the rotary kiln 9 in such a way that the burner flame 13 is arranged completely within the burnout zone 30, in particular in the axial direction in terms of the axis of rotation 29. It is also essential that the diameter D_{F} of the burner flame 13 is less than the reduced diameter D_{red}. Direct flame contact of the fire protection internals 57 is prevented.

Deflector plates 58 are arranged in the heat transfer region 31 and are fastened in particular to the inside of the rotary kiln 9. The deflector plates 58 are configured open and are for creating a material curtain 59. It is particularly advantageous for the material curtain 59 to be as dense as possible. It is possible to quantify the density of the material curtain 59 indirectly, in particular by measuring the exhaust gas temperature. The lower the exhaust gas temperature, the greater the previous heat transfer to the material. This means that the lower the exhaust gas temperature, the denser the material curtain 59, and vice versa. The exhaust gas temperature results from the burner output, the pre-metering output, in other words the mass flow rate of the material supplied to the rotary kiln 9, and the material temperature. The material temperature serves in particular as an input variable for controlling the burner output. It has been found to be advantageous for the exhaust gas temperature in the embodiment shown to be at least 100° C.

It will be appreciated that, depending on the material used, the burner 12 used or the combustion gases used, the exhaust gas temperature for monitoring the material curtain 59 may take on different values.

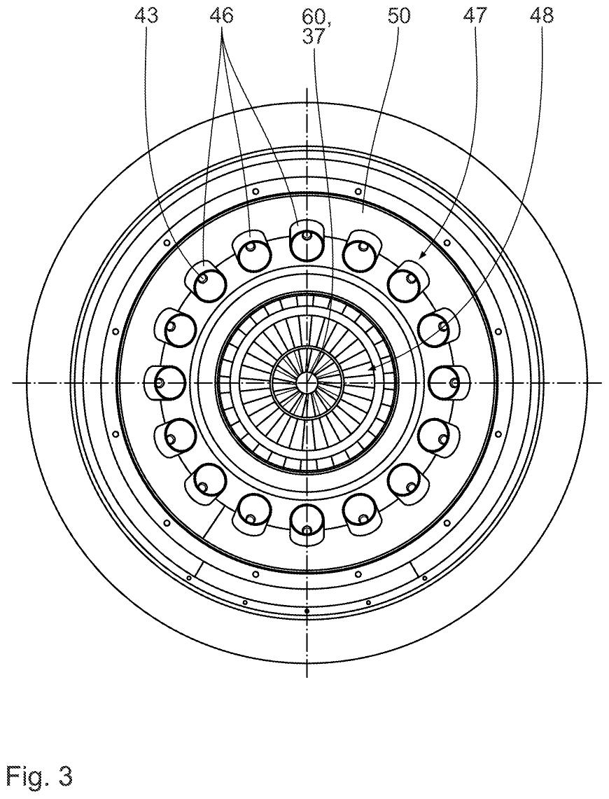

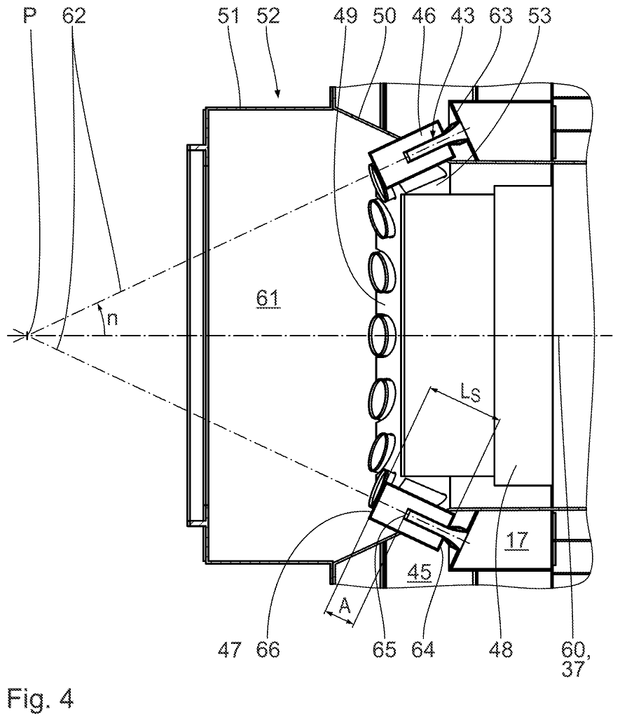

The nozzle arrangement 47 is explained in greater detail in the following with reference to FIG. 3 to 5.

The nozzle arrangement 47 is for injecting gases into the burner 12, in particular into the burner head 52. The nozzle arrangement 47 has a plurality of nozzle pairs, 16 in the embodiment shown, arranged annularly, in particular concentrically, about the longitudinal axis 37 of the burner housing 38. This annular arrangement has an arrangement centre axis 60 which coincides with the longitudinal axis 37. In the circumferential direction around the arrangement centre axis 60, the nozzle pairs are arranged mutually spaced apart and in particular evenly spaced apart. It will be appreciated that more or fewer than 16 nozzle pairs may be present. In particular, the circumferential distances from one another may be selected to be different from one another and in particular in any desired manner.

Each nozzle pair comprises a fuel gas nozzle 43 for injecting the fuel gas into a combustion chamber 61 of the burner 12. The combustion chamber 61 is understood to be the region of the burner 12 enclosed by the burner head 52 and facing the opening of the burner 12. The fuel gas nozzle is connected to the fuel gas distribution chamber 17, and is thus in fluid communication with the fuel gas distribution chamber 17. The fuel gas distribution chamber 17 is annular about the longitudinal axis 37 of the burner housing 38. The fuel gas nozzle 43 has a fuel gas nozzle longitudinal axis 62 arranged inclined at an angle of inclination n to the longitudinal axis 37. In particular, the nozzle pairs are each arranged at the angle of inclination n to the arrangement centre axis 60, in such a way that the fuel gas nozzle longitudinal axes 62 intersect. In particular, all fuel gas nozzle longitudinal axes 62 intersect at a common point P, which is in particular on the arrangement centre axis 60.

The fuel gas nozzle 43 is in particular an inner nozzle. The fuel gas nozzle 43 is arranged at least in part within the secondary gas nozzle 46 along the longitudinal axis 62 of the fuel gas nozzle.

Each nozzle pair further comprises a secondary gas nozzle 46 for injecting secondary gas into the combustion chamber 61. The secondary gas nozzle 46 is substantially a hollow cylinder and is in particular arranged concentric with the combustion gas nozzle longitudinal axis 62. The secondary gas nozzle 46 is in particular configured in a single piece and in particular as a cylindrical sleeve.

The secondary gas nozzle 46 is connected to the secondary gas distribution chamber 45. The secondary gas distribution chamber 45 extends annularly about the longitudinal axis 37 of the burner housing 38. What is essential is that the secondary gas distribution chamber 45 is configured separate from the fuel gas distribution chamber 17.

In the circumferential direction around the fuel gas nozzle longitudinal axis 62, the secondary gas nozzle 46 encloses the fuel gas nozzle 43, in particular completely. The secondary gas nozzle 46 forms an outer nozzle arranged in a sleeve-like manner around the fuel gas nozzle 43. The secondary gas nozzle 46 is arranged spaced apart at an axial distance from a side wall 63 of the fuel gas distribution chamber 17 in terms of the fuel gas nozzle longitudinal axis 62. This spaced arrangement results in an inflow gap between the side wall 63 and the end opening 64 of the secondary gas nozzle 46 facing the secondary gas distribution chamber 45.

The fuel gas nozzle 43 has a fuel gas discharge opening 65 arranged within the secondary gas nozzle 46. This makes pre-mixing of the fuel gas with the secondary gas possible in the secondary gas nozzle 46.

In particular, the fuel gas discharge opening 65 is arranged with an opening spacing A, orientated along the fuel gas nozzle longitudinal axis 62, from a secondary gas discharge opening 66 of the secondary gas nozzle 46. The opening spacing A is at least 10% of a length L_{S} of the secondary gas nozzle 46.

The fuel gas nozzle 43 has a tapered portion 67 and a constant portion 68 following along the fuel gas nozzle longitudinal axis 62. The tapered portion 67 faces the fuel gas distribution chamber 17. The fuel gas nozzle 43 is in particular configured in a single piece.

In the tapered portion, the cross-sectional area of the fuel gas nozzle 43 is reduced along the fuel gas nozzle longitudinal axis 62. The cross-sectional area reduction is in particular regressive, but may also be configured linear. The external contour of the tapered portion 47 is correspondingly configured concave or conical. The cross-sectional shape perpendicular to the fuel gas nozzle longitudinal axis 62 is in particular circular, but may also be of a different shape, in particular oval or polygonal.

The constant portion is in particular configured cylindrical. What is essential is that the transition from the tapered portion to the constant portion is continuous and in particular edge-free.

The fuel gas nozzle 43 is configured funnel-shaped or bugle-shaped overall.

The minimum cross-sectional area of the tapered portion 67 is at most 50% of the maximum cross-sectional area of the tapered portion 67.

The operation of the plant 1, in particular the functionality of the burner 12 comprising the nozzle arrangement 47, is explained in greater detail in the following.

In the first device 2, material is supplied to the rotary kiln 9 via the material inlet 10 and conveyed through the rotary kiln 9 along the material conveying direction 20. In the heat transfer region 21, the deflector plates 58 create a dense, continuous and homogeneous material curtain 59, in such a way that the material is arranged with a very large surface area within the rotary kiln 9. The material is heated by convection using the burner flame 13, the burner flame 13 being arranged directly within the rotary kiln 9.

The burner flame 13 is generated by the burner 12, which is operated with hydrogen as fuel gas. The hydrogen gas combustion can be slowed by adding secondary gas, in particular returned exhaust gas and/or inert gas. This reduces the fuel gas conversion per unit volume. High-temperature zones are prevented. In particular, it is ensured that the high-temperature zones are located exclusively within the burnout zone 30.

Both the fuel gas and the secondary gases are advantageously injected by means of the nozzle arrangement 47 shown in FIG. 3 to 5. The fuel gas, in particular hydrogen, is provided in the burner 12 via the fuel gas distribution chamber 17 and injected via the fuel gas nozzles 43. As a result of the special configuration of the fuel gas nozzle 43, in particular with the tapered portion 67, the fuel gas is advantageously drawn in and discharged at a comparatively high injection speed at the fuel gas nozzle discharge opening 65. The fuel gas is discharged into the secondary gas nozzle 46, which draws in secondary gas from the secondary gas distribution chamber 45 via the end opening 64. The intake speed of the secondary gas is lower than the injection speed of the fuel gas. This speed difference between the fuel gas and secondary gas results in improved mixing of the fuel gas with the secondary gas. Mixing occurs in particular within the secondary gas nozzle 46. The secondary gas nozzle 46 forms a mixing chamber for mixing the fuel gas and secondary gas. It is also advantageous that the fuel gas is injected into the secondary gas nozzle 46 centrally, in other words concentrically.

By adding secondary gas, in other words in particular purified exhaust gas and/or inert gas, high-temperature zones and thus the formation of nitrogen oxides are reduced.

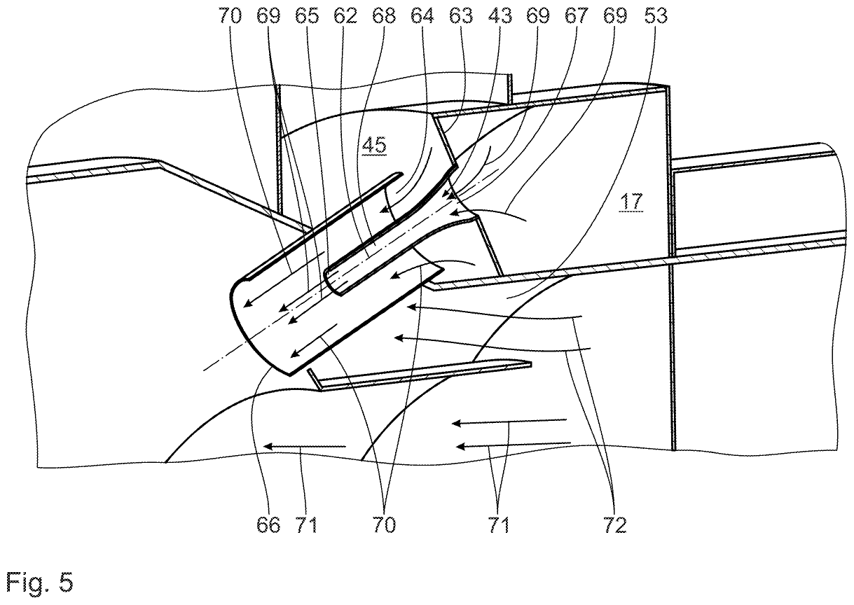

In particular, the nozzle arrangement according to the invention ensures advantageous mixing of fuel gas and secondary gas, in particular before contact of the fuel gas with the combustion air occurs in the combustion chamber 61. The fluid flows are shown schematically in FIG. 5. Flow arrows 69 indicate the fuel gas, flow arrows 70 the secondary gas, flow arrows 71 the primary air, and flow arrows 72 the secondary air.

1-10. (canceled)

11. A burner device for a plant for producing asphalt, the burner device comprising:
a rotary kiln drivable in rotation about an axis of rotation for drying material; and
a burner coupled to the rotary kiln and configured to supply heat to the rotary kiln, the burner including
an intake chamber configured to draw in air,
a fuel gas line coupled to the burner and configured to supply fuel gas, and
at least one secondary gas line coupled to the burner and configured to supply secondary gas.

12. The burner device according to claim 11, wherein the at least one secondary gas line includes an exhaust gas return line for returning exhaust gas from the burner device to the burner.

13. The burner device according to claim 12, wherein the exhaust gas return line is fluidly coupled to at least one of a) the rotary kiln or 2) at least one further exhaust gas source of the burner device.

14. The burner device according to claim 12, wherein the exhaust gas return line is coupled to an exhaust gas purification unit.

15. The burner device according to claim 12, wherein the at least one secondary gas line has an inert gas line configured to supply inert gas to the burner.

16. The burner device according to claim 12, further including a mixing chamber configured to mix fuel gas and secondary gas.

17. The burner device according to claim 16, wherein the fuel gas line and the secondary gas line are coupled to the mixing chamber.

18. The burner device according to claim 16, further including an air line coupled directly to the burner and configured to guide air past the mixing chamber.

19. A plant for producing asphalt comprising a burner device according to claim 11.

20. A method for supplying heat to a rotary kiln of a burner device in an asphalt plant, the steps comprising:
supplying fuel gas to a burner via a fuel gas line;
supplying secondary gas to the burner via a secondary gas line;
supplying air to the burner; and
burning the fuel gas and the air in the burner in the presence of the secondary gas.
